(19) United States
(12) Patent Application Publication
(10) Pub. No.: US 2021/0298544 A1
(43) Pub. Date: Sep. 30, 2021

(54) Wet Vacuum Assembly And Suction Head Combination

(71) Applicant: Dave Jansa, Sioux Falls, SD (US)

(72) Inventor: Dave Jansa, Sioux Falls, SD (US)

(21) Appl. No.: 16/835,490

(22) Filed: Mar. 31, 2020

(51) Int. Cl. A47L 7/00; A47L 9/32; A47L 9/12

(52) U.S. Cl. CPC A47L 7/0009; A47L 9/009; A47L 9/122; A47L 9/327

(57) ABSTRACT

A wet vacuum assembly and suction head combination assembly for dislodging and cleaning landscaping materials, such as landscape rock includes a wet vacuum assembly and a suction head. The wet vacuum assembly generates an airflow through a tube thereof. The suction head is engaged to the tube distal from the wet vacuum assembly so that an interior space, which is defined by the suction head, is in fluidic communication with the tube. The suction head has an opening positioned in a bottom thereof. A set of nozzles is coupled to a top of the suction head and is engageable a hose, which extends from a source of pressurized water. The nozzles direct a spray of water from the hose through the interior space to dislodge objects, such as landscape rock embedded in a surface, and to clean the objects that now are entrained in the airflow.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vacuum assemblies and more particularly pertains to a new vacuum assembly for dislodging and cleaning landscaping materials, such as landscape rock.

### (2) Description of Related Art Including Information Disclosed Under 37 CFR 1.97 and 1.98

The prior art relates to vacuum assemblies. Prior art devices for cleaning landscape rock may comprise a vacuum powered separation module for generating an airflow having debris and landscape rock entrained therein, wherein the rock is separated from the debris when a speed of the airflow is reduced. The prior art does not teach the combination of vacuum induced airflow and water spray disclosed herein.

### BRIEF SUMMARY OF THE INVENTION

An embodiment of the disclosure meets the needs presented above by generally comprising a wet vacuum assembly and a suction head. The wet vacuum assembly is configured to generate an airflow through a tube thereof. The suction head is engaged to the tube distal from the wet vacuum assembly so that an interior space, which is defined by the suction head, is in fluidic communication with the tube. The suction head has an opening positioned in a bottom thereof. A set of nozzles is coupled to a top of the suction head and is configured to engage a hose, which extends from a source of pressurized water. The nozzles are configured to direct a spray of water from the hose through the interior space to dislodge objects, such as landscape rock, wood chips, mulch, and the like, which embedded in a surface, and to clean the objects that now are entrained in the airflow.

In one embodiment, the wet vacuum assembly and suction head combination comprises a cannister, which has a vacuum module coupled to an upper end thereof. The tube extends from the cannister proximate to the upper end. A plurality of wheels is coupled to a lower end of the cannister. In these respects, the wet vacuum assembly and suction head combination of this embodiment is similar to an off-the-shelf wet/dry vacuum. The water source to supply the set of nozzles in this embodiment may comprise a garden hose. An internal screen is selectively positionable within, and engageable to, the cannister. The internal screen defines an upper chamber and a lower chamber and is configured to separate the objects, such as the landscape rocks, from the water and the debris in the airflow.

In another embodiment, the wet vacuum assembly and suction head combination comprises a platform, which is mobile. The platform may comprise a trailer, which is configured to be selectively hitched to a vehicle so that the platform is towable. In this embodiment, the source of pressurized water comprises a first tank and a pump, which are positioned on the platform. The first tank is configured to hold water. The pump is operationally engaged to the first tank and to the hose and thus is configured to pump the water from the first tank through the hose to the set of nozzles.

A vacuum unit and a second tank also are positioned on the platform. A conduit is engaged to and extends between the vacuum unit and the second tank so that the second tank is in fluidic communication with the vacuum unit. The tube extends from the second tank to the suction head. The second tank is configured to hold the objects, such as the landscape rock, the debris, and the water from the airflow. A screening unit is selectively positionable inline between the second tank and the suction head. The screening unit is configured to extract the objects from the airflow while leaving the debris entrained in the airflow.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a suction head of a wet vacuum assembly and suction head combination according to an embodiment of the disclosure.

FIG. 2 is a side view of a suction head of an embodiment of the disclosure.

FIG. 3 is a bottom view of a suction head of an embodiment of the disclosure.

FIG. 4 is a cross-sectional view of a suction head of an embodiment of the disclosure.

FIG. 5 is an in-use view of a wet vacuum assembly and suction head combination of the disclosure.

FIG. 6 is an in-use view of a wet vacuum assembly and suction head combination of the disclosure.

FIG. 7 is an in-use view of an embodiment of the disclosure.

FIG. 8 is an in-use view of an alternative embodiment of the disclosure.

### DETAILED DESCRIPTION OF THE INVENTION

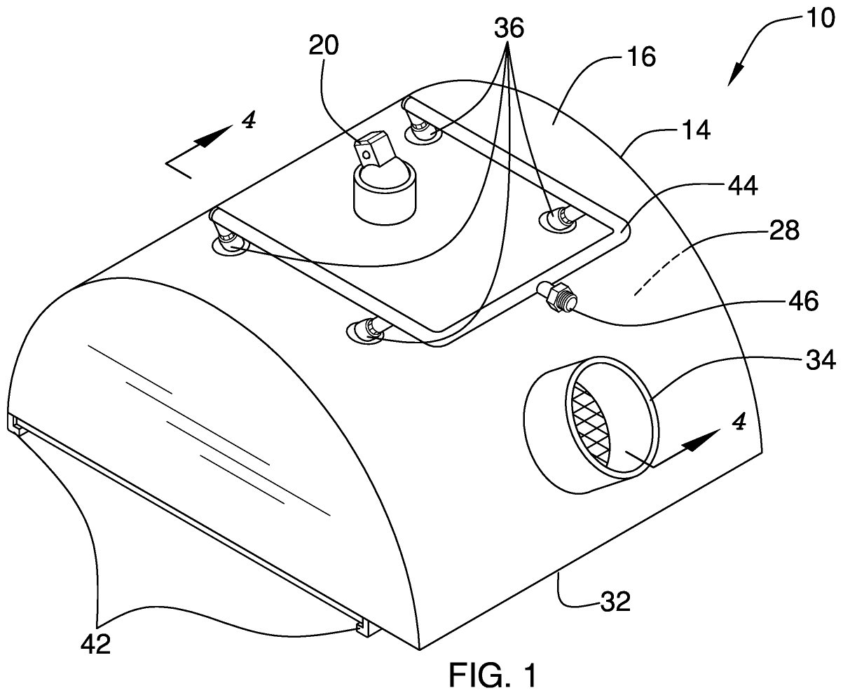

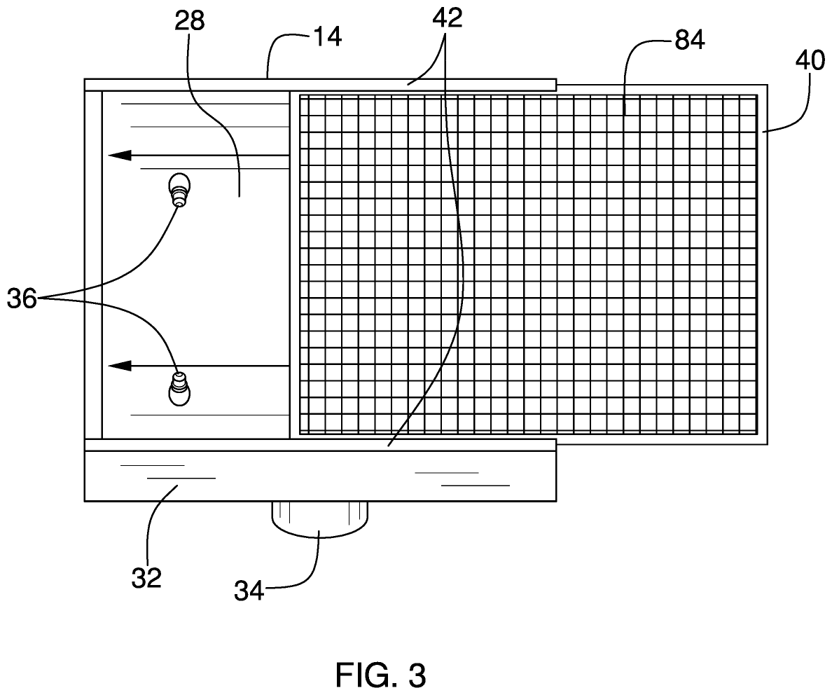

With reference now to the drawings, and in particular to FIGS. 1 through 8 thereof, a new vacuum assembly embodying the principles and concepts of an embodiment of the disclosure and generally designated by the reference numeral 10 will be described.

As best illustrated in FIGS. 1 through 8, the wet vacuum assembly and suction head combination 10 generally comprises a wet vacuum assembly 12 and a suction head 14. The suction head 14 may be substantially half barrel shaped, as shown in FIG. 1, so that a top 16 of the suction head 14 is arcuate. The suction head 14 also may be alternatively shaped, such as rectangularly box shaped, disc shaped, and the like.

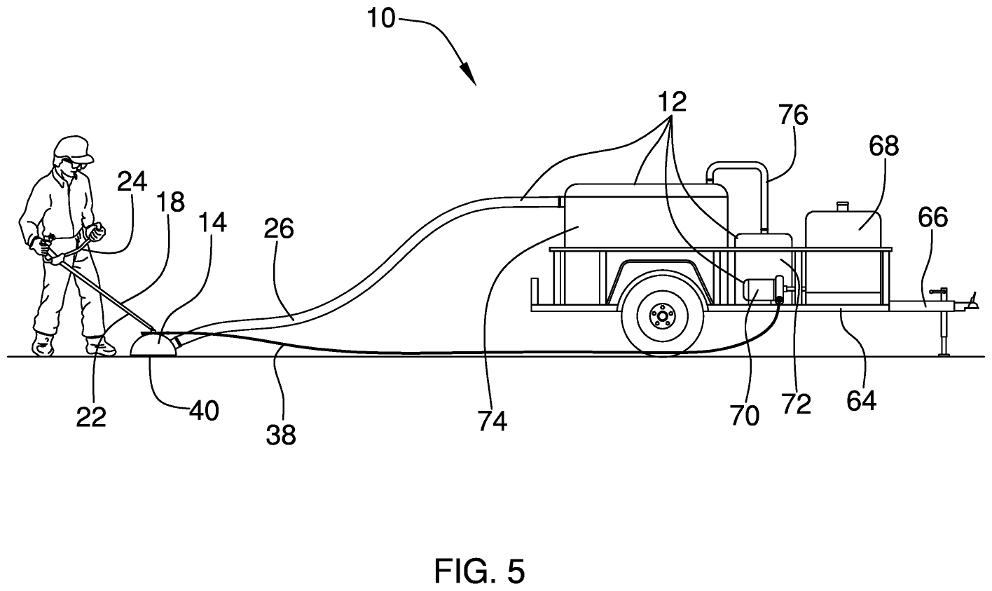

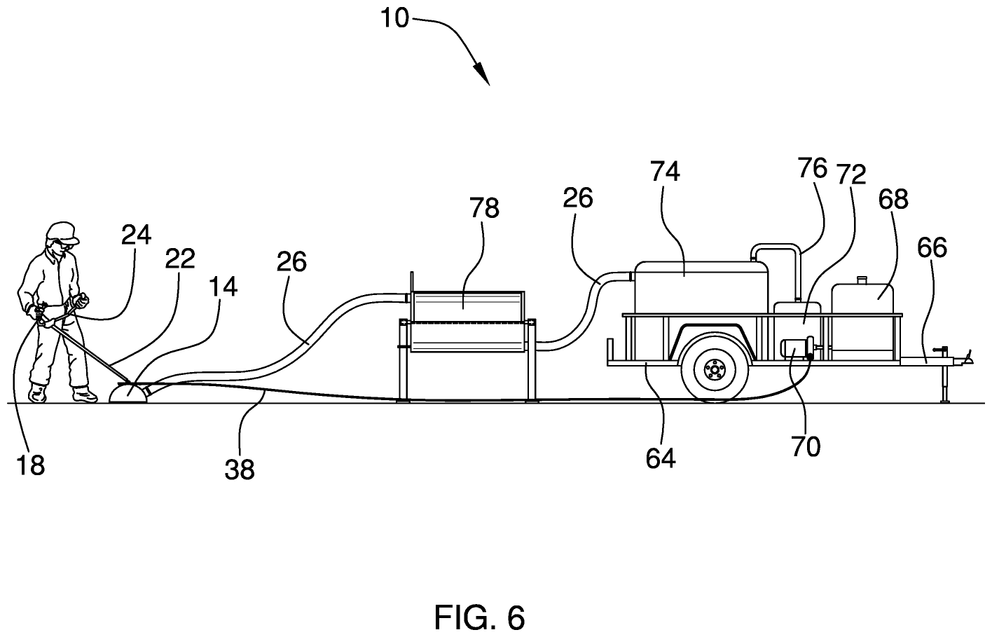

A handle 18 is engaged to and extends from the suction head 14 and is configured to be grasped in a hand of a user to maneuver the suction head 14. A ball joint 20 is engaged to and positioned between the suction head 14 and the handle 18 so that the handle 18 is pivotable relative to the suction head 14. The handle 18 may comprise a first rod 22 and a second rod 24, as shown in FIGS. 5 and 6. The first rod 22 is engaged to and extends from the suction head 14. The second rod 24 is coupled to and extends bidirectionally and arcuately from the first rod 22 distal from the suction head 14. The second rod 24 is configured to be grasped in a pair of hands of the user to maneuver the suction head 14.

The present invention also anticipates the suction head 14 being selectively engageable to a mini-excavator (not shown), allowing the user to utilize the mini-excavator to position and manipulate the suction head 14.

The wet vacuum assembly 12 is configured to generate an airflow through a tube 26 thereof. The suction head 14 is engaged to the tube 26 distal from the wet vacuum assembly 12 so that an interior space 28, which is defined by the suction head 14, is in fluidic communication with the tube 26. The suction head 14 has an opening 30 positioned in a bottom 32 thereof. The suction head 14 may have a pipe 34 coupled thereto and extending therefrom. The pipe 34 is configured to selectively engage the tube 26 of the wet vacuum assembly 12 so that the tube 26 is removably engageable to the suction head 14.

A set of nozzles 36 is coupled to the top 16 of the suction head 14 and is configured to engage a hose 38, which extends from a source of pressurized water. The nozzles 36 are configured to direct a spray of water from the hose 38 through the interior space 28 to dislodge objects, such as landscape rock embedded in a surface, and to clean the objects that now are entrained in the airflow. The set of nozzles 36 may comprise four nozzles 36, as shown in FIG. 1, or other number of nozzles 36, such as, one to three nozzles 36 and five or more nozzles 36.

A head screen 40 is selectively engageable to the suction head 14 so that the head screen 40 extends over the opening 30. The head screen 40 is configured to exclude objects larger than a mesh size 84 of the head screen 40. The objects larger than the mesh size 84 are cleaned by the spray of water from the hose 38 but are excluded from the interior space 28. The present invention anticipates head screens 40 having a variety of mesh sizes 84 for use with objects of various sizes.

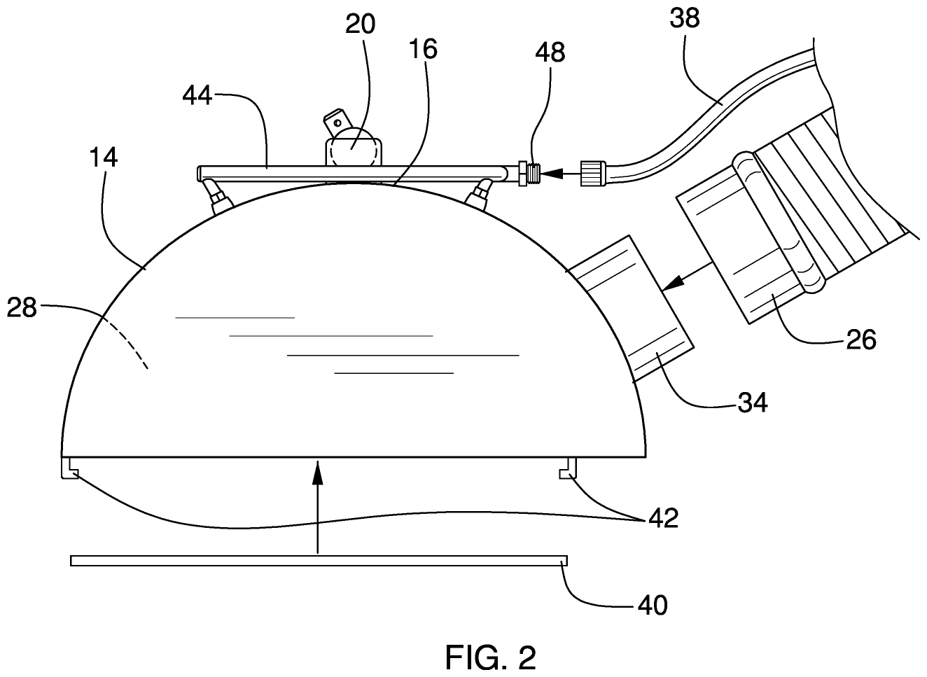

A pair of rails 42 is coupled to the bottom 32 so that the rails 42 bracket the opening 30, as shown in FIG. 2. The head screen 40 is selectively insertable between the rails 42 to removably engage the head screen 40 to the suction head 14 to cover the opening 30.

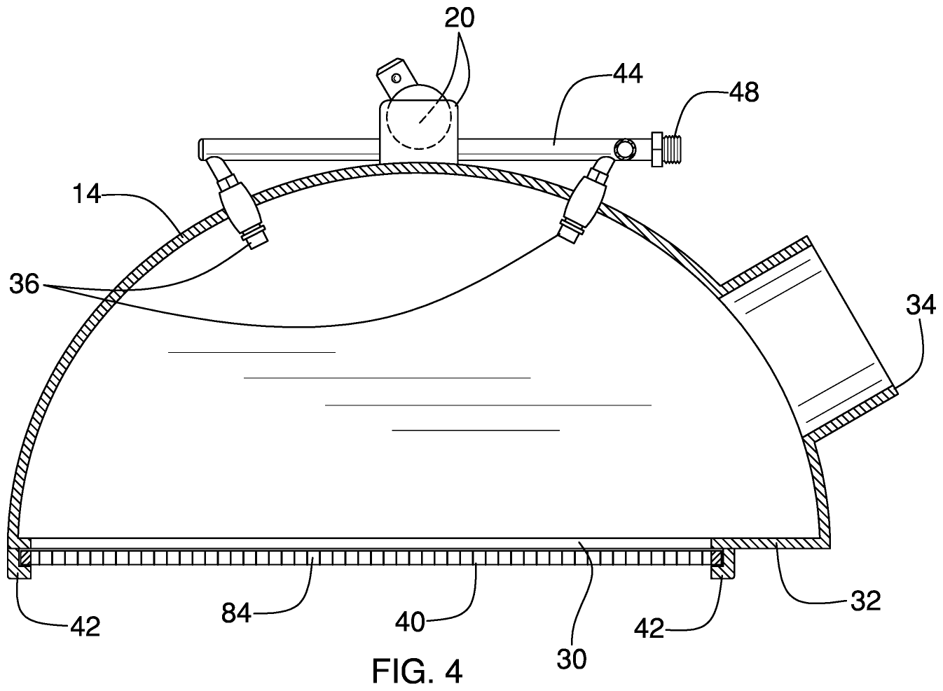

A manifold 44 is engaged to and is in fluidic communication with the set of nozzles 36. A connector 46 is coupled to the manifold 44 and is configured to engage the hose 38 that extends from the source of the pressurized water. The connector 46 may comprise a male hose connection 48, as shown in FIG. 4, or other connecting means, such as, but not limited to, quick connects, camlocks, and the like. A valve 50 is engaged to and positioned between the connector 46 and the hose 38. The valve 50 is configured to control flow of the water from the hose 38 to the manifold 44. The valve 50 is positioned conveniently to be accessed by the user during operation of the wet vacuum assembly and suction head combination 10.

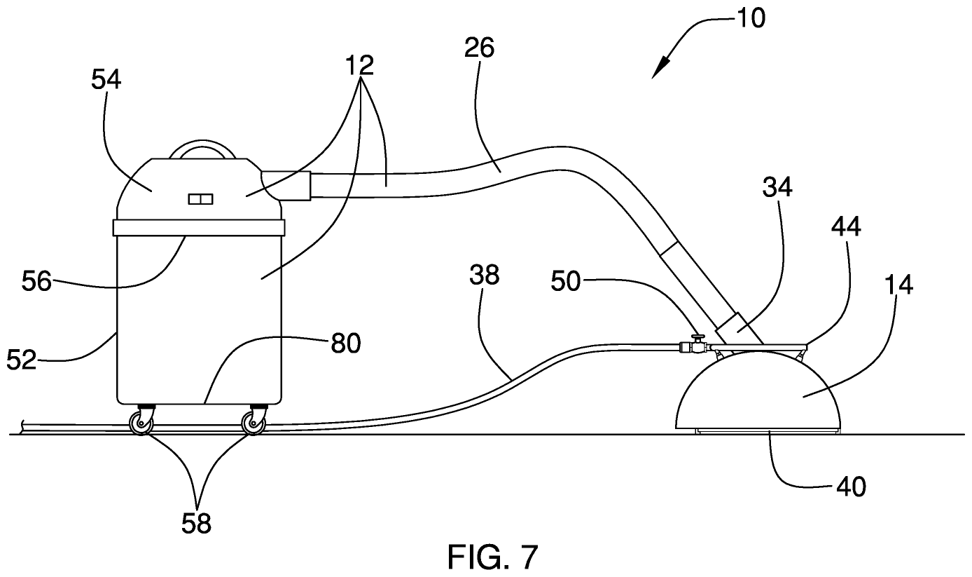

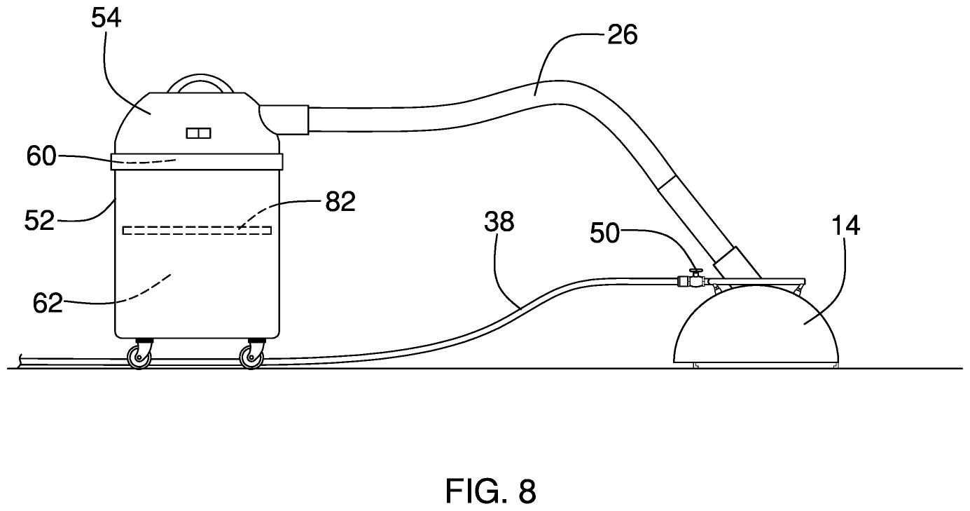

In one embodiment, as shown in FIGS. 7 and 8, the wet vacuum assembly 12 comprises a cannister 52, which has a vacuum module 54 coupled to an upper end 56 thereof. The tube 26 extends from the cannister 52 proximate to the upper end 56. A plurality of wheels 58 is coupled to a lower end 80 of the cannister 52. In these respects, the wet vacuum assembly 12 of this embodiment is similar to an off the shelf wet/dry vacuum. The water source to supply the set of nozzles in this embodiment may comprise a garden hose. An internal screen 82 is selectively positionable within, and engageable to, the cannister 52. The internal screen 82 defines an upper chamber 60 and a lower chamber 62 and is configured to separate the objects, which collect in the upper chamber 60, from the water and the debris in the airflow.

In another embodiment, as shown in FIGS. 5 and 6, the wet vacuum assembly 12 comprises a platform 64, which is mobile. The platform 64 may comprise a trailer 66, which is configured to be selectively hitched to a vehicle so that the platform 64 is towable. The present invention also anticipates the platform 64 comprising a motorized vehicle, such as a flatbed truck, a van, and the like.

In this embodiment, the source of pressurized water comprises a first tank 68 and a pump 70, which are positioned on the platform 64. The first tank 68 is configured to hold water. The pump 70 is operationally engaged to the first tank 68 and to the hose 38 and thus is configured to pump the water from the first tank 68 through the hose 38 to the set of nozzles 36.

A vacuum unit 72 and a second tank 74 are positioned on the platform 64. A conduit 76 is engaged to and extends between the vacuum unit 72 and the second tank 74 so that the second tank 74 is in fluidic communication with the vacuum unit 72. The tube 26 extends from the second tank 74 to the suction head 14. The second tank 74 is configured to hold the objects, such as the landscape rock, wood chips, mulch, and the like, along with the debris and the water from the airflow. A screening unit 78 is selectively positionable inline between the second tank 74 and the suction head 14. The screening unit 78 is configured to extract the objects from the airflow while leaving the debris entrained in the airflow.

In use, the suction head 14 is engaged to the tube 26. If the objects are to be cleaned and immediately returned to the surface, the head screen 40 is inserted between the rails 42 to cover the opening 30 in the suction head 14. The wet vacuum assembly 12 is actuated to start the airflow through the tube 26 and the interior space 28. The source of pressurized water also is actuated to initiate the spray of water from the nozzles 36. The objects are cleaned of debris by the spray but are prevented from entering the interior space 28 by the head screen 40.

If the objects are be cleaned and removed from the surface, the head screen 40 is not used. The wet vacuum assembly 12 and the source of pressurized water are actuated, as above. However, without the head screen 40 in place the objects are still cleaned of debris, but also passes through the interior space 28 and the tube 26. With the objects removed from the surface, the user can perform maintenance of the surface, such as repair or replacement of a weed barrier, prior to repositioning the objects on the surface. In one embodiment, the objects are collected on the internal screen 82 in the cannister 52, while in another embodiment the objects are collected in the screening unit 78.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A wet vacuum assembly and suction head combination comprising:
a wet vacuum assembly configured for generating an airflow through a tube thereof;
a suction head engaged to the tube distal from the wet vacuum assembly such that an interior space defined by the suction head is in fluidic communication with the tube, the suction head having an opening positioned in a bottom thereof; and
a set of nozzles coupled to a top of the suction head and being configured for engaging a hose extending from a source of pressurized water, wherein the nozzles are configured for directing a spray of water from the hose through the interior space for dislodging objects embedded in a surface, wherein the wet vacuum assembly is configured for entraining the objects in the airflow, positioning the set of nozzles for cleaning the objects entrained in the airflow.

2. The wet vacuum assembly and suction head combination of claim 1,
wherein the suction head is substantially half barrel shaped such that the top of the suction head is arcuate.

3. The wet vacuum assembly and suction head combination of claim 1, further including a handle engaged to and extending from the suction head wherein the handle is configured for grasping in a hand of a user for maneuvering the suction head.

4. The wet vacuum assembly and suction head combination of claim 3, wherein the handle comprises:
a first rod engaged to and extending from the suction head; and
a second rod coupled to and extending bidirectionally and arcuately from the first rod distal from the suction head, wherein the second rod is configured for grasping in a pair of hands of the user for maneuvering the suction head.

5. The wet vacuum assembly and suction head combination of claim 3, further including a ball joint engaged to and positioned between the suction head and the handle such that the handle is pivotable relative to the suction head.

6. The wet vacuum assembly and suction head combination of claim 1, wherein the set of nozzles comprises four nozzles.

7. The wet vacuum assembly and suction head combination of claim 1, further including a pipe coupled to and extending from the suction head and being configured for selectively engaging the tube of the wet vacuum assembly, such that the tube is removably engageable to the suction head.

8. The wet vacuum assembly and suction head combination of claim 1, further including a head screen selectively engageable to the suction head such that the head screen extends over the opening, wherein the head screen is configured for excluding objects larger than a mesh size of the head screen, such that the objects larger than the mesh size are cleaned by the spray of water from the hose but are excluded from the interior space.

9. The wet vacuum assembly and suction head combination of claim 8, further including a pair of rails coupled to the bottom such that the rails bracket the opening, the head screen being selectively insertable between the rails for removably engaging the head screen to the suction head for covering the opening.

10. The wet vacuum assembly and suction head combination of claim 1, further including:
a manifold engaged to and in fluidic communication with the set of nozzles; and
a connector coupled to the manifold and being configured for engaging the hose extending from the source of the pressurized water.

11. The wet vacuum assembly and suction head combination of claim 10, wherein the connector comprises a male hose connection.

12. The wet vacuum assembly and suction head combination of claim 10, further including a valve engaged to and positioned between the connector and the hose wherein the valve is configured for controlling flow of the water from the hose to the manifold.

13. The wet vacuum assembly and suction head combination of claim 1, further including the wet vacuum assembly comprising:
a cannister having a vacuum module coupled to an upper end thereof, the tube extending from the cannister proximate to the upper end;
a plurality of wheels coupled to a lower end of the cannister; and
an internal screen selectively positionable within and engageable to the cannister, such that the internal screen defines an upper chamber and a lower chamber, wherein the internal screen is configured for separating the objects from the water and the debris in the airflow.

14. The wet vacuum assembly and suction head combination of claim 1, further including the wet vacuum assembly comprising:
a platform, the platform being mobile;
the source of pressurized water comprising a first tank and a pump positioned on the platform, the first tank and being configured for holding water, the pump being operationally engaged to the first tank and to the hose wherein the pump is configured for pumping the water from the first tank through the hose to the set of nozzles;
a vacuum unit positioned on the platform;
a second tank positioned on the platform; and
a conduit engaged to and extending between the vacuum unit and the second tank, such that the second tank is in fluidic communication with the vacuum unit, the tube extending from the second tank to the suction head, wherein the second tank is configured for holding the objects, the debris and the water from the airflow.

15. The wet vacuum assembly and suction head combination of claim 14, wherein the platform comprises a trailer configured to be selectively hitched to a vehicle, such that the platform is towable.

16. The wet vacuum assembly and suction head combination of claim 14, further including a screening unit selectively positionable inline between the second tank and the suction head, the screening unit being configured for extracting the objects from the airflow while leaving the debris entrained in the airflow.

17. A suction head and wet vacuum assembly combination comprising:
a wet vacuum assembly configured for generating an airflow through a tube thereof;
a suction head engaged to the tube distal from the wet vacuum assembly such that an interior space defined by the suction head is in fluidic communication with the tube, the suction head having an opening positioned in a bottom thereof, the suction head being substantially half barrel shaped such that a top of the suction head is arcuate;
a handle engaged to and extending from the suction head wherein the handle is configured for grasping in a hand of a user for maneuvering the suction head, the handle comprising a first rod and a second rod, the first rod being engaged to and extending from the suction head, the second rod being coupled to and extending bidirectionally and arcuately from the first rod distal from the suction head wherein the second rod is configured for grasping in a pair of hands of the user for maneuvering the suction head;
a ball joint engaged to and positioned between the suction head and the handle such that the handle is pivotable relative to the suction head;
a set of nozzles coupled to the top of the suction head and being configured for engaging a hose extending from a source of pressurized water, wherein the nozzles are configured for directing a spray of water from the hose through the interior space for dislodging objects embedded in a surface, wherein the wet vacuum assembly is configured for entraining the objects in the airflow, positioning the set of nozzles for cleaning the objects entrained in the airflow, the set of nozzles comprising four nozzles;
a pipe coupled to and extending from the suction head and being configured for selectively engaging the tube of the wet vacuum assembly, such that the tube is removably engageable to the suction head;
a head screen selectively engageable to the suction head such that the head screen extends over the opening, wherein the head screen is configured for excluding objects larger than a mesh size of the head screen, such that the objects larger than the mesh size are cleaned by the spray of water from the hose but are excluded from the interior space;
a pair of rails coupled to the bottom such that the rails bracket the opening, the head screen being selectively insertable between the rails for removably engaging the head screen to the suction head for covering the opening;
a manifold engaged to and in fluidic communication with the set of nozzles;
a connector coupled to the manifold and being configured for engaging the hose extending from the source of the pressurized water, the connector comprising a male hose connection; and
a valve engaged to and positioned between the connector and the hose wherein the valve is configured for controlling flow of the water from the hose to the manifold.

18. The wet vacuum assembly and suction head combination of claim 17, further including the wet vacuum assembly comprising:
a cannister having a vacuum module coupled to an upper end thereof, the tube extending from the cannister proximate to the upper end;
a plurality of wheels coupled to a lower end of the cannister; and
an internal screen selectively positionable within and engageable to the cannister, such that the internal screen defines an upper chamber and a lower chamber, wherein the internal screen is configured for separating the objects from the water and the debris in the airflow.

19. The wet vacuum assembly and suction head combination of claim 17, further including the wet vacuum assembly comprising:
a platform, the platform being mobile, the platform comprising a trailer configured to be selectively hitched to a vehicle, such that the platform is towable;
the source of pressurized water comprising a first tank and a pump positioned on the platform, the first tank and being configured for holding water, the pump being operationally engaged to the first tank and to the hose wherein the pump is configured for pumping the water from the first tank through the hose to the set of nozzles;
a vacuum unit positioned on the platform;
a second tank positioned on the platform;
a conduit engaged to and extending between the vacuum unit and the second tank, such that the second tank is in fluidic communication with the vacuum unit, the tube extending from the second tank to the suction head, wherein the second tank is configured for holding the objects, the debris and the water from the airflow; and
a screening unit selectively positionable inline between the second tank and the suction head, the screening unit being configured for extracting the objects from the airflow while leaving the debris entrained in the airflow.
